(19) United States
(12) Patent Application Publication
(10) Pub. No.: US 2009/0306941 A1
(43) Pub. Date: Dec. 10, 2009

(54) Structure Model description and use for scatterometry-based semiconductor manufacturing process metrology

(76) Inventors: Michael Kotelyanskii, Chatham, NJ (US); Xueping Ru, Washington, NJ (US); Robert G. Wolf, Hackettstown, NJ (US); Yue Yang, Millburn, NJ (US)

Correspondence Address: HARRINGTON & SMITH, PC, 4 RESEARCH DRIVE, Suite 202, SHELTON, CT, 06484-6212, US

(21) Appl. No.: 12/227,387

(22) PCT Filed: May 14, 2007
(86) PCT No.: PCT/US2007/011586

§ 371 Date: Jun. 26, 2009

Related U.S. Application Data
(60) Provisional application No. 60/800,897, filed on May 15, 2006.

(51) Int. Cl. G06F 17/50

(52) U.S. Cl. 703/1

(57) ABSTRACT

A method includes accessing a structure model defining a cross-sectional profile of a structure on a sample. The cross-sectional profile is at least partially defined using a set of blocks. Each of the blocks includes a number of vertices. One or more of the vertices are expressed using one or more algebraic relationships between a number of parameters corresponding to the structure. Information is evaluated from the structure model to produce expected metrology data for a scatterometry-based optical metrology. The expected metrology data is suitable for use for determining one or more of the number of parameters corresponding to the structure. Apparatus are also disclosed.

### TECHNICAL FIELD

This invention relates generally to semiconductor metrology such as scatterometry and, more specifically, relates to modeling structures on a semiconductor in order to determine parameters of the structures.

### BACKGROUND

Optical measurements of semiconductors and accompanying structures thereon provide fast, accurate, non-destructive, and relatively inexpensive analysis techniques. With the increasing integration density and operating frequencies of microelectronic devices, the dimensions of the basic integrated circuits (IC) components shrink, and transistor gate structures become two- and three-dimensional. As the structure dimensions become less than or comparable to light wavelengths being used in optical measurement, simple imaging like microscopy is generally not possible, and the optical measurements require analysis of the intensity and the polarization state of the light scattered off the structures on the semiconductor. Further, optical metrology measurements performed on multilayered films are no longer sufficient, and characterization of the two- and three-dimensional structure elements of the structures is generally required in addition to the measurements.

Such characterization is typically performed using a structure model. In a measurement system using a structure model, structure dimensions of a structure are extracted from optical measurements of the structure by calculating light scattering parameters for a structure model chosen to represent the structure on the semiconductor and by finding the model parameter values providing the best fit between the modeled and measured light scattering parameters. The way in which the structure model is described and parameters of the structure model are selected is very important for efficient and accurate measurement.

Typical structures manufactured for an integrated circuit (IC) include a number of elements, manufactured from a number of materials. For instance, Thompson, et al., A Logic Nanotechnology Featuring Strained-Silicon, IEEE Electron Device Letters, Vol. 25, No. 4 (April 2004) describes both p-type and T-type metal-oxide-semiconductor field effect transistors (NOSFETs). The p-type MOSFET in Thompson includes a thin dielectric layer, deposited on top of a silicon channel, the channel surrounded by straining elements designed to strain the channel, where the straining elements are filled with a Si—Ge alloy. The gate in this transistor may be made of amorphous Si or metal, and is surrounded by spacer elements. The n-type MOSFET also includes a thin dielectric layer, deposited on top of a silicon channel, but the straining element is a Si-nitride capping layer that surrounds the gate element, which again may be made of amorphous Si or metal and is surrounded by spacer elements. The gates of the p-type and n-type MOSFETs in Thompson are three-dimensional structures that can be described using a cross-sectional profile. Even more complex structures, with a gate dielectric wrapped around the silicon channel, are described in Huang et al., “Sub-50 nm P-Channel FinFET”, IEEE Transactions on Electron Devices, Vol. 48, No. 5, (May 2001).

As transistor gate structures have become more complex, structure models to represent the structures have also become more complex. The description provided by the structure models for the scattering-based metrology software has to be general and, simultaneously, flexible enough to allow description of the structure model with the right level of detail to meet measurement accuracy requirements. At the same time, it is beneficial for the structure models to use the fewest number of parameters possible in order to make modeling efficient, and also to make structure modeling software easier to use. Currently, structure models and their corresponding software are inefficient from a modeling perspective, and relatively hard to use.

It would therefore be desirable to provide structure models that are general, flexible, efficient, and easy to use.

### BRIEF SUMMARY

In an exemplary embodiment, a method is disclosed. The method includes accessing a structure model. The structure model defines a cross-sectional profile of a structure on a sample. The cross-sectional profile is defined at least partially using a set of blocks. Each of the blocks includes a number of vertices. Each vertex is expressed using one or more algebraic relationships between a number of parameters corresponding to the structure. Information is evaluated from the structure model to produce expected metrology data for a scatterometry-based optical metrology. Measured metrology data is accessed, the measured metrology data determined by examining the structure on the sample using the scatterometry-based optical metrology. The expected metrology data and the measured metrology data are compared in order to determine one or more of the number of parameters corresponding to the structure.

In another exemplary embodiment, a metrology system includes a processing element configured to access a structure model defining a cross-sectional profile of a structure on a sample, the cross-sectional profile at least partially defined using a set of blocks, each of the blocks including a plurality of vertices, each vertex expressed using at least one algebraic relationship between a plurality of parameters corresponding to the structure. The processing element is further configured to evaluate information from the structure model to produce expected metrology data for a scatterometry-based optical metrology. The processing element is also configured to accessing measured metrology data, the measured metrology data determined by examining the structure on the sample using the scatterometry-based optical metrology, and the processing element is further configured to compare the expected metrology data and the measured metrology data in order to determine at least one of the plurality of parameters corresponding to the structure.

In another exemplary embodiment, a method includes accessing a structure model defining a cross-sectional profile of a structure on a sample. The cross-sectional profile is at least partially defined using a set of blocks. Each of the blocks includes a number of vertices. One or more of the vertices are expressed using one or more algebraic relationships between a number of parameters corresponding to the structure. Information is evaluated from the structure model to produce expected metrology data for a scatterometry-based optical metrology. The expected metrology data is suitable for use for determining one or more of the number of parameters corresponding to the structure.

In a further exemplary embodiment, a metrology system is disclosed that includes a processing element configured to access a structure model defining a cross-sectional profile of a structure on a sample, the cross-sectional profile at least partially defined using a set of blocks, each of the blocks including a plurality of vertices, at least one of the vertices expressed using at least one algebraic relationship between a plurality of parameters corresponding to the structure. The processing element is further configured to evaluate information from the structure model to produce expected metrology data for a scatterometry-based optical metrology, the expected metrology data suitable for use for determining at least one of the plurality of parameters corresponding to the structure.

### BRIEF DESCRIPTION OF THE DRAWINGS

The foregoing and other aspects of embodiments of this invention are made more evident in the following Detailed Description of Exemplary Embodiments, when read in conjunction with the attached Drawing Figures, wherein:

FIG. 1 is an exemplary scatterometry-based system for structure model description and use for scatterometry-based semiconductor manufacturing process metrology in accordance with an exemplary embodiment of the invention;

FIG. 2 is a flowchart of an exemplary method for setting up a structure model;

FIG. 3 is a flowchart of an exemplary method for defining structure blocks used to define structures of a semiconductor;

FIG. 4 is a diagram illustrating a graphical representation of a simplified portion of a structure model for a strained n-type MOSFET structure, including blocks and model parameters;

FIG. 5 is a diagram illustrating a graphical representation of a simplified portion of a structure model for the strained n-type MOSFET structure of FIG. 4, including blocks and vertices;

FIG. 6 is a flowchart of an exemplary method for using the structure model for determining using an iterative process, parameters corresponding to a structure on a sample;

FIG. 7A is a flowchart of an exemplary method for using the structure model for determining a table of parameters for a number of defined structures; and

FIG. 7B is a flowchart of an exemplary method for determining parameters corresponding to a structure on a sample using stored parameters for a number of defined structures.

### DETAILED DESCRIPTION OF EXEMPLARY EMBODIMENTS

In an exemplary embodiment, a method is presented for describing and parameterizing a structure model of two-dimensional or three-dimensional periodic or standalone structures for a scattering-based metrology. Techniques are disclosed for setting up a structure model and for implementing supporting modules such as software modules. The model structure is represented as a set of blocks. In an exemplary embodiment, each block includes one material, and does not overlap with any other block. In an exemplary embodiment, material properties are assumed to be constant within a block. Blocks can assume one of a number of predefined shapes consistent with the algorithm used to calculate the solution for the scattering problem.

Further structure subdivision may be performed automatically by the software based on the information provided by describing the block shapes, positions, and constituent materials. Such structure subdivision is useful for mesh generation for finite differences or finite elements methods and is useful for slicing for the Rigorous Coupled Wave Analysis (RCWA) algorithms.

Coordinates of the vertices of the blocks and the dimensions of the blocks are defined via the relationships formulated in terms of the model parameters. The equations describing these relationships are user-defined and therefore are not subject to limitations of the fixed format of the modeling software. The equations are entered by the user when the structure model is defined and become part of the model “recipe”. The equations typically relate vertex coordinates of blocks to parameters of the materials that define the block. For instance, assume a simple example of a gate electrode that is formed from a polysilicon layer, having an exemplary thickness of “T_poly”. Each vertex is characterized by two coordinates (e.g., an x coordinate and a z coordinate), each of which is in turn defined using an equation that contains parameters. The “T_Poly” parameter will naturally enter equations for the vertices of the block that represent the gate electrode.

The modeling software interprets and evaluates these equations when scattering analysis algorithms such as the RCWA algorithm are applied. When the scattering analysis algorithm determines a “best fit” between measured metrology data of the structure(s) on a sample and expected metrology data of the structure model of the structure(s), the block vertices then provide output structure parameters that can for instance indicate height (e.g., Tpoly) and width (e.g., another user defined parameter) of the gate electrode.

Such arrangement provides flexibility to define almost any possible structure arrangement, and allows at the same time using a reduced set (as compared to conventional systems) of the model parameters relevant for the semiconductor process control.

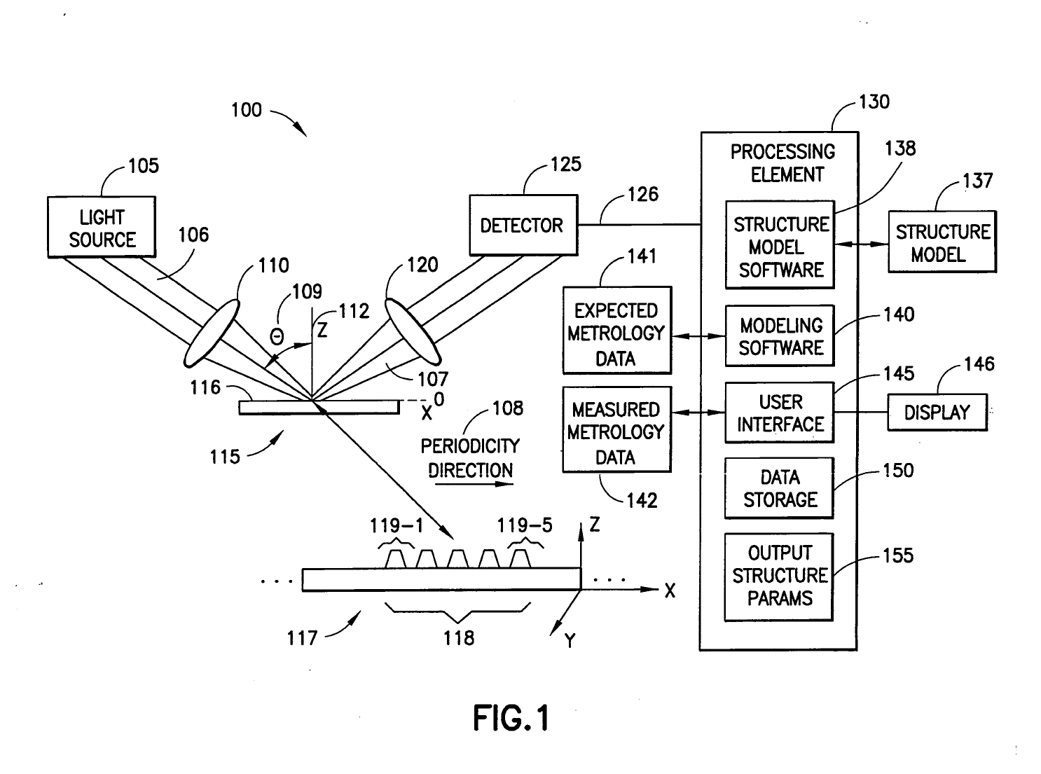

An exemplary scatterometry-based metrology system 100 is shown in FIG. 1. Metrology system 100 comprises a light source 105, a lens 110, a lens 120, a detector 125, and a processing element 130. The metrology system 100 operates to perform scatterometry-based metrology on sample 115. It should be noted that system 100 is used merely for expository purposes and may not include all elements of a general metrology system 100. For example, metrology system 100 could also include one or more polarizers, multiple lenses, and coherent or incoherent light sources. Further, typical scatterometry-based metrology involves optical measurement of a structure using ellipsometry, reflectometry, or their combination, as described in the numerous previous patents, such as U.S. Pat. No. 6,429,943 to Opsal et al., U.S. Pat. No. 6,713,753 to Rovira et al., U.S. Pat. No. 6,721,052 to Zhao et al. Metrology system 100 may include any such optical metrology techniques such as ellipsometry techniques, reflectometry techniques, or the combination of ellipsometry and reflectometry, or any other optical metrology technique suitable for scatterometry.

The light source 105 produces a light beam 106 (typically called a “probe beam”) that is focused by lens 110 onto part of the sample 115. The sample 115 is typically a semiconductor but may be other materials having one or more structures thereon. The sample 115 includes a sample portion 117 have a structure array 118. The structure array 118 includes single structure 119-1 through single structure 119-5. The light beam 106 reflects off the sample 115 (e.g., and a portion or all of the structure array 118) as a reflected light beam 107. The reflected light beam 107 passes through the lens 120, which directs the reflected light beam 107 to the detector 125. The detector 125 produces output signals 126.

The processing element 130 comprises structure model software 135, modeling software 140, user interface 145, data storage 150, and output structure parameters 155. It should be noted that elements 135, 140, 145, 150, and 155 are described thusly merely for sake of exposition. The elements 135, 140, 145, 150, and 155 could be combined into a fewer number of elements or further subdivided into a larger number of elements. The processing element 130 may include one or more processors (not shown) coupled to one or more memories (not shown). The processing element may include, for example, multiple discrete, networked computer systems. The structure model software 135, modeling software 140, and user interface 145 are typically software comprising instructions suitable for execution by the one or more processors of the processing element 130. The structure model software 135, modeling software 140, and user interface 145 may also be embodied as a signal bearing medium tangibly embodying a program of machine-readable instructions executable by the processing element (e.g., one or more processors thereof) to perform operations described herein. Note that a processor will typically be a general-purpose processor but could also be a digital signal processor, data processor, or a processing unit custom designed to efficiently generate modeled scattering data. The structure model software 135, modeling software 140, user interface 145, data storage 150, and output structure parameters 155 are stored in one or more memories (not shown), which can be long term or short term memories such as hard drives, random access memories (RAMs), or other entities capable of storing data. The data storage 150 is in one example a long term memory used to store the structure model 137, and output structure parameters 155.

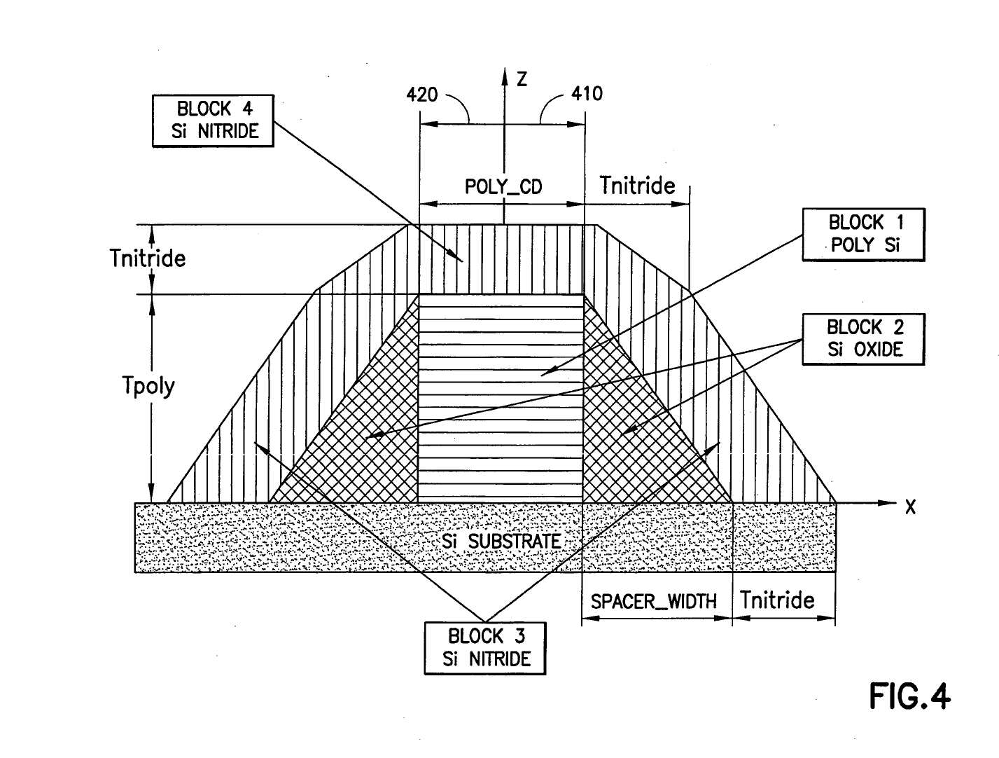

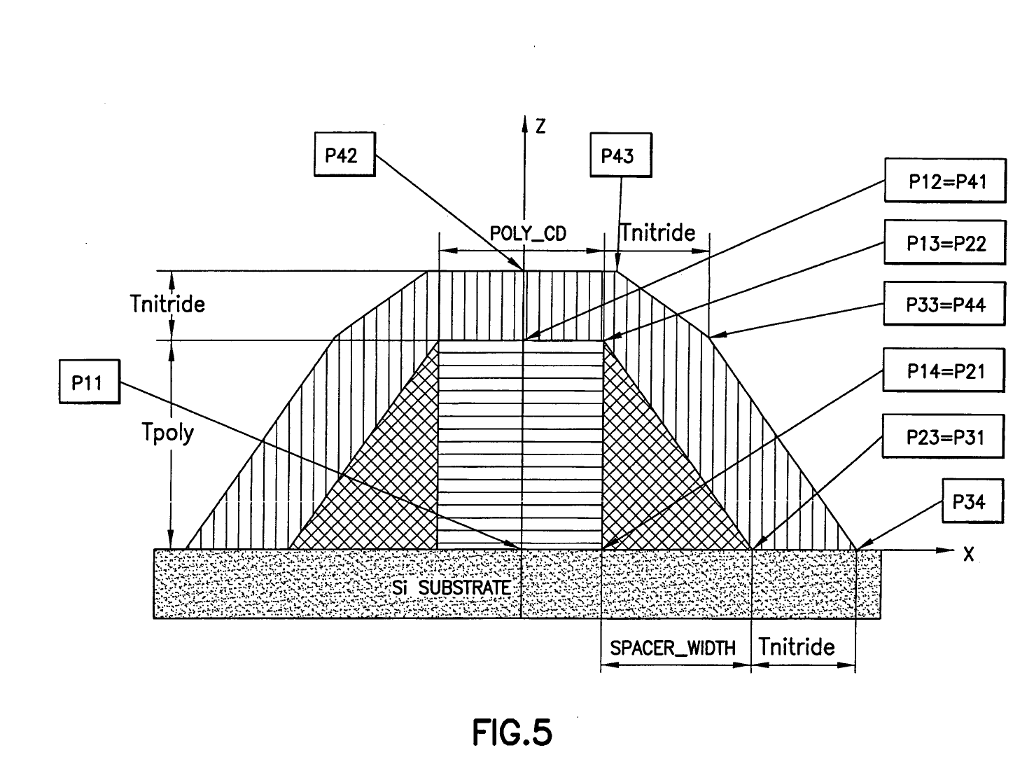

The structure model software 135 is software that interfaces with user interface 145 to allow a user to define a structure model 137 (e.g., a graphical representation of a portion of which is shown in FIGS. 4 and 5). The user interface 145 interfaces with one or more displays 146 in order to provide access to the structure model software 135 and to the modeling software 140 and to display the output structure parameters 155. The structure model software 135 provides the structure model 137 to the modeling software 140. The modeling software 140 analyzes the structure model 137 in order to determine expected metrology data 141 (e.g., expected reflectivity data, expected ellipsometry data, or both). The modeling software 140 also analyzes the detector output signals 126 to determine measured metrology data 142 (e.g., measured reflectivity data, measured ellipsometry data, or both).

Extraction of the values of the structure parameters of interest, e.g., for process control, involves by the modeling software 140 finding the best fit between the measured metrology data 142 and their theoretical values (e.g., expected metrology data 141), predicted by model calculations. Modeling by the modeling software 140 typically involves analyzing the scattering problem for various values of the model parameters (e.g., represented by the structure model 137), and finding the “best fit” via non-linear optimization, library interpolation, or both. The output of the modeling software 140 includes output structure parameters 155, which are the structure parameters found as being the “best fit” from a scattering problem analysis. In one exemplary embodiment, the scattering problem analysis is an iterative process that is repeated until differences (e.g., as measured by some metric) between the expected and measured metrology data meet some predetermined error. When this predetermined error is reached, the “best fif” is found. As another example, the “best fit” occurs for differences (e.g., as measured by some metric) between the expected and measured metrology data such that the error is a minimum. The predetermined error in this example can be a minimum error determined relative to a number of difference calculations.

The structure model software 135 provides a user with tools to define structure model 137 of the structure(s) on the sample 115. Model definition involves, e.g., defining the shapes, dimensions, and the type and distribution of the material within the structure. This is done in terms of the parameters of the model. Variations of these parameters describe the possible structure variations among which the values best fitting the measurement are to be found. Thus, it is desirable to minimize the number of such parameters, and at the same time, to provide sampling of all the variations of the structures that are expected based on the nature of the manufacturing process. Embodiments herein have fewer parameters than conventional systems while also providing suitable sampling of variations of the structures.

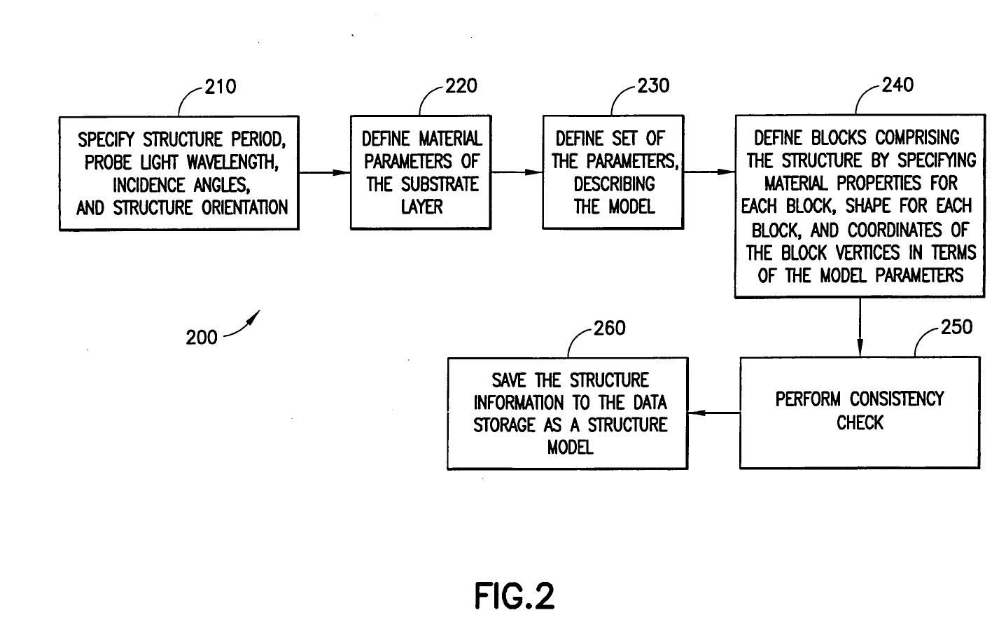

Turning to FIG. 2 with appropriate reference to FIG. 1, a flowchart is shown of an exemplary method 200 for setting up a structure model 137. Method 200 is shown for the case of the optics-based scatterometry metrology. Method 200 is performed by the structure model software 135 and the interaction of structure model software 135, user interface 145, and a user (not shown). Method 200 involves the following exemplary steps.

In step 210, the structure model software 135 allows a user to specify the structure period (e.g., of the structure array 118) and probe light parameters (e.g., of the light beam 106). The probe light parameters include wavelength(s), polarization, incidence angle 109 (see FIG. 1), and structure orientation. An incidence plane is the plane that contains the incident beam (e.g., light beam 106), and a vector 112, normal to the surface 116 of the sample 115. The angle of incidence 109, θ, is the angle between the incident beam (e.g., light beam 106) and the vector 112 normal to the surface 116. Note that incidence angle 109 could be a range of angles as defined by the lens 110. In the example of FIG. 1, the angle of incidence 109 is measured using the middle of the light beam 106. Additionally, in the example of FIG. 1, the incidence plane is the x-z plane.

The structure orientation is typically entered as an angle describing the periodicity direction 108 of the structure array 118 relative to the incidence plane (e.g., the x-z plane in FIG. 1). In the example of FIG. 1, both the orientation of the incident light beam and the periodicity direction 108 are in the same relative direction (i.e., the x axis) and the angle would be zero. If the sample 115 were rotated 90 degrees, such that the periodicity direction 108 would be along the y axis, the azimuth angle would be 90 degrees.

In step 220, the structure model software 135 allows the user to define material parameters of the substrate layer. Such parameters could include optical properties of the material, such as dependence of the complex refractive index on the wavelength.

In step 230, the structure model software 135 allows the user to define a set of model parameters describing geometry that at least partially defines or that is later used to help define a single structure 119 or the structure array 118. For instance, a thickness of a polysilicon layer (e.g., “T_poly”) may be defined that will become a gate electrode. Similarly, a thickness of a nitride layer (e.g., “Tnitride”) that is placed over MOSFETs may also be entered at this stage. As another example, a width of a poly-silicon line (e.g., “Poly_CD”) may be entered, where the Poly_CD is used to define a width of the gate electrode. In principle, anything that relates to the dimensions or distances within the model can be included as a model parameter. Exemplary model parameters can include an angle between the side-wall and the silicon substrate, for instance.

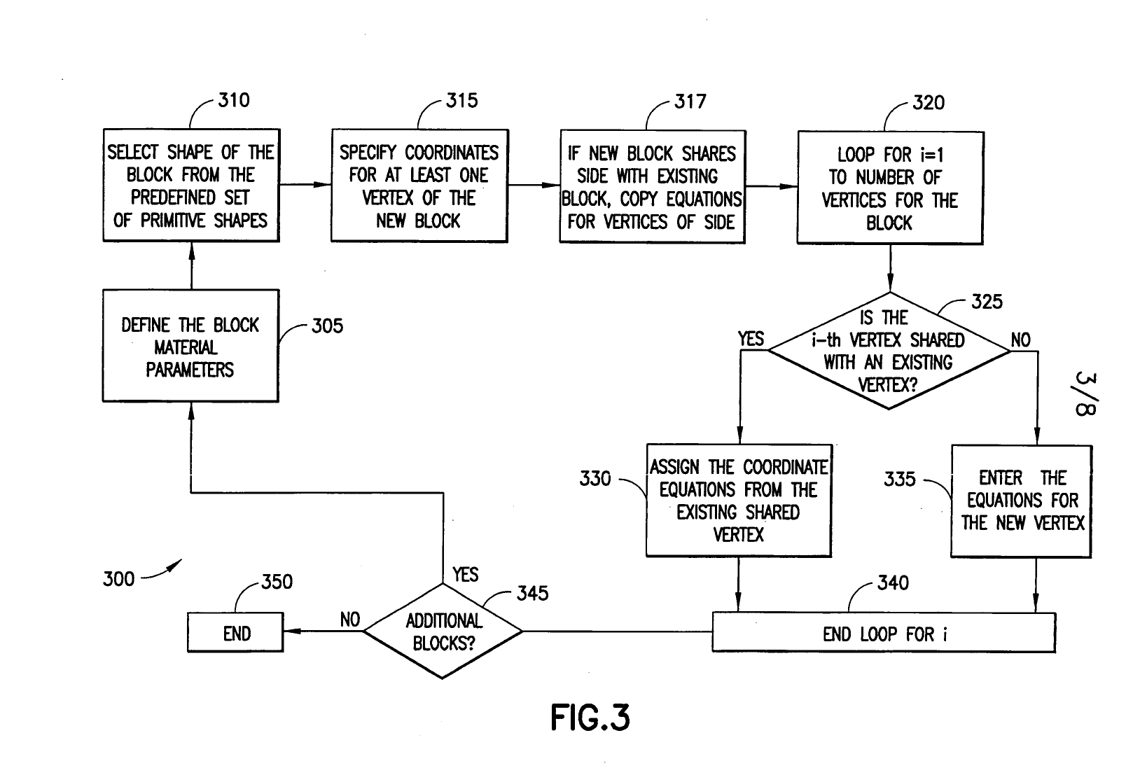

In step 240, blocks of different materials, comprising the structure(s), are introduced sequentially. Each block is defined by its material and shape. Coordinates for each of the block vertices are entered. Vertices are defined either as coincident with the vertices of other blocks already introduced, or via entering new equations for coordinates in terms of the model parameters. The structure model software 135 acts in concert with the user interface 145 to update a graphical representation (see FIGS. 4 and 5) of the structure(s) on the display(s) 146 whenever an existing element is changed or a new element is added. Block 240 is described in more detail in FIG. 3.

In step 250, the structure model software 135 performs a consistency check for the entered structure(s). This may be, but is not limited to, checking for accidental block overlaps or erroneously introduced gaps between the blocks. Any errors can be examined and fixed by a user in step 250.

In step 260, the structure model 137 is saved to the non-volatile, long-term computer memory storage in the data storage 150.

Referring now to FIG. 3 in addition to FIGS. 1 and 2, a flowchart is shown of an exemplary method 300 for defining structure blocks used to define structures of a semiconductor. Method 300 includes a more detailed explanation of step 240 of FIG. 2. Method 300 is performed by the structure model software 135 and the interaction of structure model software 135, user interface 145, and a user (not shown). Method 300 involves the following steps.

In an exemplary embodiment, a structure model is described as a collection of blocks. In an exemplary embodiment, material properties are constant within the blocks and blocks are not overlapping. In step 305, the structure model software 135 allows a user to define the block material parameters, such as material properties, for a block.

In step 310, the structure model software 135 allows a user to select block shapes are selected from a set of pre-defined primitives, such as, but not limited to triangular, quadrangle, circular sector shapes. Shapes of the sides of the blocks can be restricted to satisfy the limitation of the scattering solution technique. For instance, if rigorous coupled wave analysis (RCWA) is used, triangular and quadrangle blocks would have one of the sides parallel to the substrate surface plane, and quadrangular blocks must have two sides parallel to the substrate surface plane. An exemplary reference describing RCWA is Moharam and Gaylord, “Rigorous coupled-wave analysis of metallic-surface relief gratings”, J. Opt. Soc. Am. A, vol. 3, 1780-1781 (November 1986). Other analysis techniques may have similar limitations. These limitations can therefore restrict certain aspects of the primitives.

In step 315, the structure model software 135 allows the user to specify coordinate(s) for at least one vertex of the new block. Step 315 might be performed by allowing the user to place the block on a graphical representation (e.g., on display 146) of the structure(s). Such placement could allow the structure model software 135 to determine equations forone ormore vertices of the just-placed block. In another exemplary embodiment, the user could manually enter equations for a vertex of the selected, new block.

In step 317, if the new block shares a side with an existing block, the equations for the vertices of the side are copied from the existing block to the new block. Step 317 allows multiple vertices to be copied from an existing block to a new block, which lessens the amount of entry a user has to perform. It is noted that the user will typically inform the structure model software 135 that sides of an existing and new block are shared.

Coordinates of the block vertices are specified in terms of algebraic equations involving the model parameters. These equations are part of the structure model 137, and are expanded when the scattering problem analysis is performed. Exemplary equations are described below. Steps 315 and 317 allows one or more vertices of a block to be defined through equations, and steps 320 through 340 allow additional equations defining the remaining vertices of the new block to be entered in. In step 320, a loop is started for the number of vertices of the new block.

In step 325, it is determined if the i-th feature is shared with an existing vertex of an existing block. In step 325, the user interacts with the structure model software 135 to inform the structure model software 135 that a vertex is shared between the newly defined block and an existing block. If so (step 325 =YES), the vertex of the new block is assigned the same equations as the corresponding vertex of the existing block. This occurs in step 330. Additionally in step 330, the structure model software 135 would operate with the user interface 145 to allow the user to specify the coincident vertices of the blocks by using a pointer (e.g., mouse, joystick, or other device) or using text entry fields or through any other known technique.

If the i-th feature of the newly added block is not shared with an existing vertex of existing blocks (step 325=NO), the user in step 335 is prompted by the structure model software 135 (e.g., through the user interface 145 and the display 146) to enter the equations for the new vertex.

In step 340, the variable “i” is incremented and control passes to step 320. When the loop of steps 320-340 is complete, step 345 determines if additional blocks are to be added. If so (step 345=YES), the method 300 continues in step 305. If not (step 345=NO), the method 300 ends in step 350.

Exemplary embodiments herein include one or more of the following non-limiting exemplary features: (1) Further processing of the structure model may be performed according to requirements of the scattering analysis algorithm. For instance, further subdivision into slices may be performed for an RCWA algorithm, or mesh generation may be performed for finite-difference or finite-element based solution methods. This processing may be automated (e.g., using one or both of structure model software 135 and modeling software 140).

(2) The structure model software 135 performs consistency checking of the structure model to identify items such as block overlaps, erroneously introduced cavities between the blocks, and other errors.

(3) A user defines a set of model parameters based on whatever aspects of the application are deemed the most relevant aspects. Items such as model parameter names, values, limits, and the like are entered by the user. As a consequence, meanings for these items for the structure model (e.g., critical dimension, layer thicknesses, undercut, pitch, etc.) are not pre-determined in the software application design. In other Words, the names of the model parameters are not pre-programmed into the software. A user can select the names based on the actual parameter meaning in the context of the structure manufacturing, e.g., “T_Poly” for a thickness of a Poly layer, or “Poly_CD” for its width (also known as “critical dimension” in the industry).

(4) All dimensions in the model, including the period of a structure array, are described in terms of model parameters. Coordinates of each block vertex are defined in terms of the algebraic relationships between the model parameters. The equations are resolved into numerical values at each iteration when the scattering solution algorithm is applied and whenever structure geometry has to be defined.

(5) The structure model software 135 calculates block vertex coordinates based on the block shape and dimensions, e.g. for a rectangular block, it is sufficient to enter the height and the width. Typically, after any of four vertices is defined, the remaining the vertex coordinates can be automatically determined based on the block shape and dimensions.

(6) The structure model software 135 (e.g., or modeling software 140 or a combination of the structure model software 135 and modeling software 140) defines the most optimal subdivision of the structure model to provide the scattering problem analysis with the best calculation speed for a specified calculation accuracy. As an example, for an RCWA analysis, subdivision into slices is automated based on requirements for the maximum acceptable slice thickness for each block.

To illustrate an exemplary implementation of this invention, consider an example of creating a simplified model for the strained n-type MOSPET structure, capped with the straining silicon nitride layer as in the article by Thompson, et al., A Logic Nanotechnology Featuring Strained-Silicon, IEEE Electron Device Letters, Vol. 25, No. 4 (April 2004). An exemplary type MOSFET gate structure portion is shown in FIGS. 4 and 5.

FIGS. 4 and 5 (see also FIG. 1) show graphical representations of a simplified portion of a structure model for a strained n-type MOSFET structure. In particular, a cross-section of the gate structure portion of the n-type MOSFET is shown. The x axis is horizontal, along the periodicity direction, and the z axis is vertical, normal to the substrate. In the examples of FIGS. 4 and 5, only one gate structure portion of a structure array 118 is shown. The Z=0 level corresponds to the top of the substrate. The structure model is presented as a set of blocks, and includes not only the blocks but also equations defining the blocks. For simplicity, the structure model assumes cross-section to be symmetric relative to the vertical Z axis. Block 1 is a Poly-Si (polysilicon) gate electrode, Block 2 represents an element of the spacer layer that has created spacers after processing, and Blocks 3 and 4 represent an element of a SiN (silicon nitride) straining layer covering the gate material of the gate electrode and the spacers.

In this example, the structure model is described by only the following four parameters: Tpoly for the height (also representative of thickness) of the Poly-Si line, Poly_CD for the width of the Poly-Si line, Tnitride for the thickness of the straining Si nitride layer, and Spacer_-Width, the width of the Si Oxide spacer at the substrate level. The choice of the parameters is not unique, and may be changed to best reflect the steps of the structure manufacturing process. In this application, for instance, if the straining layer deposition process leaves the layer of material conformal to the existing features, it may be advantageous to use the same variable to describe the thickness of the straining layer on top and on the side of the gate material of the gate electrode and associated spacers.

For this particular structure, the elements to the right 410 of the z axis are mirror images of the elements to the left 420 of the z axis. Consequently, each of blocks 1 and 4 can be split in two, with each split block a mirror image of the other split block, and blocks 2 and 3 can be mirrored about the z axis.

FIG. 5 shows the vertices of each block. Pij stands for the j-th vertex of the i-th block. Thus, P42 is the second vertex of the fourth block.

The x and z coordinates for each vertex are expressed in terms of the algebraic relationships between the model parameters that describe the structure. In other words, the parameters define physical elements (e.g., thicknesses of layers, widths of layers remaining after etching) of the structure. Coincident vertices (e.g., P14 and P21) are assigned the same equations. This arrangement guarantees that as model parameter values change in the course of model optimization, the blocks remain attached to each other. In an exemplary embodiment, a software implementation of this invention provides a technique to pick up the vertex of the newly defined block by making the vertex coincide with the already defined vertex, and assigning the same equations for the vertex coordinates for both newly defined and already defined vertices. This is accomplished, e.g., by selecting an existing vertex by the block and vertex numbers, by using a pointer (e.g., mouse or joystick) to drive the cursor over the structure drawing of the structure model, or through some other known technique.

The following table shows the equations for the vertices for the simple structure model illustrated in FIGS. 4 and 5:

| Block | Vertex | | |
|---|---|---|---|
| # | # | Equation for X | Equation for Z |
| 1 | 1 | 0 | 0 |
| 1 | 2 | 0 | Tpoly |
| 1 | 3 | 0.5*Poly_CD | Tpoly |
| 1 | 4 | 0.5*Poly_CD | 0 |
| 2 | 1 | 0.5*Poly_CD | 0 |
| 2 | 2 | 0.5*Poly_CD | Tpoly |
| 2 | 3 | 0.5*Poly_CD + Spacer_Width | 0 |
| 3 | 1 | 0.5*Poly_CD + Spacer_Width | 0 |
| 3 | 2 | 0.5*Poly_CD | Tpoly |
| 3 | 3 | 0.5*Poly_CD + Tnitride | Tpoly |
| 3 | 4 | 0.5*Poly_CD + Spacer_Width + | 0 |
| | | Tnitride | |
| 4 | 1 | 0 | Tpoly |
| 4 | 2 | 0 | Tpoly + Tnitride |
| 4 | 3 | 0.5*Poly_CD | Tpoly + Tnitride |
| 4 | 4 | 0.5*Poly_CD + Tnitride | Tpoly |

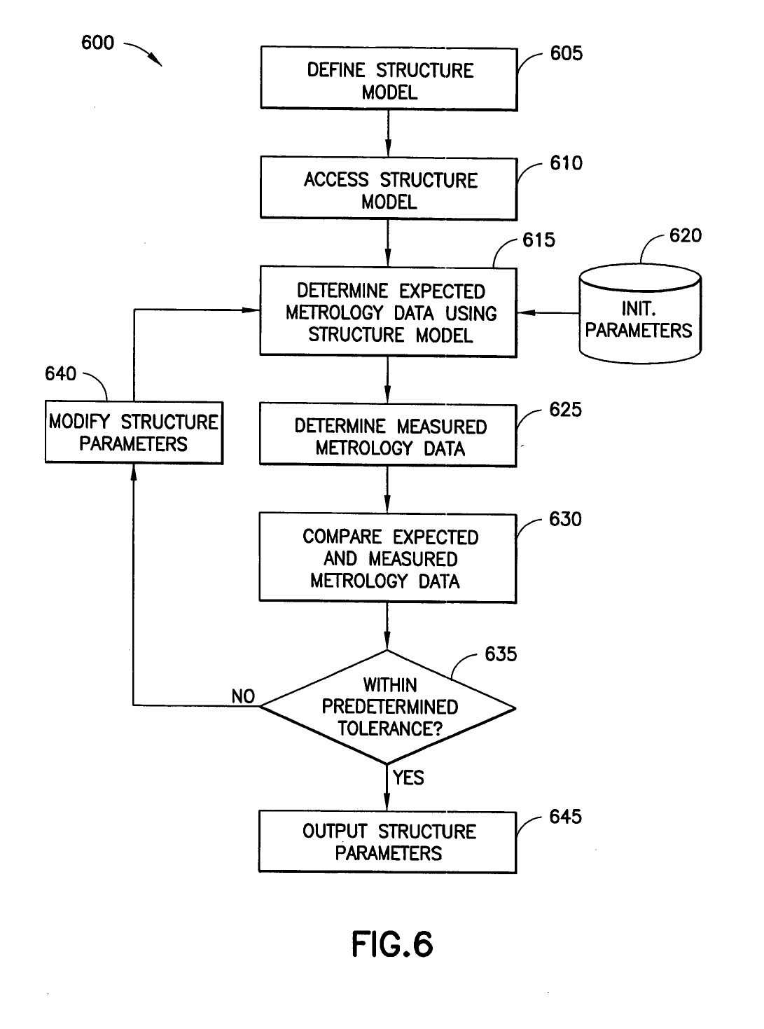

Turning now to FIG. 6 with appropriate reference to preceding figures, a flowchart is shown of an exemplary method 600 for using the structure model for determining, using an iterative process, parameters corresponding to a structure on a sample. Method 600 begins in step 605 when a user defines (e.g., using structure model software 135 and user interface 145 of FIG. 1) the structure model (e.g., structure model 137 of FIG. 1). Such definition has been described above in reference to FIGS. 2-5. In step 610, the structure model 137 is accessed. Step 610 may be performed, for instance, by the modeling software 140 accessing the structure model software 135, which then returns the structure model 137 to the modeling software 140. As another example, the modeling software 140 accesses the structure model 137 directly.

In step 615, expected metrology data (e.g., expected metrology data 141) is determined using the structure model 137. In a non-limiting embodiment, step 615 would be performed by the modeling software 140, as would steps 625-645. Typically, a set of initial parameters 620 would be used to provide some starting point. Step 615 may also determine the initial parameters. For instance, widths could be assigned as critical dimensions (e.g., the smallest possible dimensions for the manufacturing techniques being used). In step 625, a metrology system 100 measures a structure (e.g., structure array 118) on a sample and determines measured metrology data (e.g., measured metrology data 142).

In step 630, the modeling software 140 compares expected and measured metrology data. If the expected and measured metrology data are within a predetermined tolerance (step 635=YES), the modeling software 140 outputs structure parameters in step 645. The structure parameters correspond to the structure and can include one or more of the parameters described above. It is noted that the predetermined tolerance could be an error, as described previously. It should also be noted that step 625 might be performed such that measure metrology data is stored in step 625 and step 630 can simply access the stored metrology data. If the expected and measured metrology data are not within a predetermined tolerance (step 635=NO), then the structure parameters are modified in step 640 and steps 615, 625, 630, and 635 are performed again.

Thus, method 600 shows an iterative process for determining structure parameters where structure parameters for a structure model are modified during the process. In method 600, the output structure parameters are determined without reference to a stored table of structure parameters. A benefit to method 600 is that the output structure parameters are not limited to discrete values of structure parameters. A detriment is the time required to perform the iterative process.

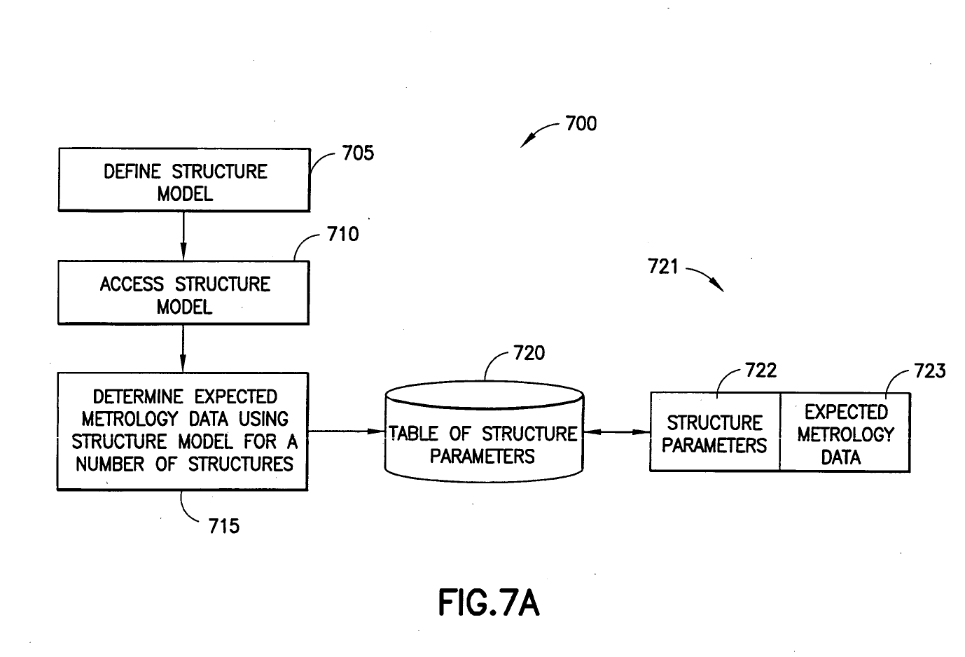

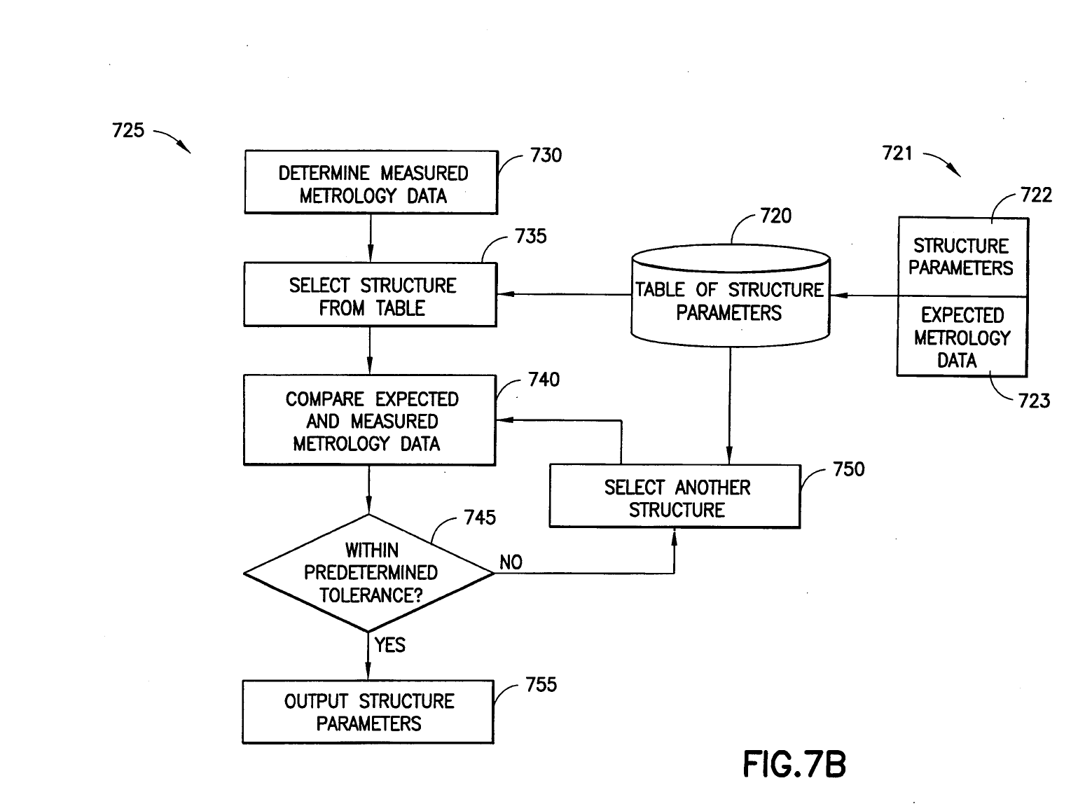

By contrast, FIGS. 7A and 7B show methods where structure parameters for a structure model are determined and stored for a number of defined different structures (FIG. 7A). The stored structure parameters are subsequently used to determine structure parameters that are deemed to be the structure parameters corresponding to a structure on a sample (FIG. 7B).

Referring to FIG. 7A with appropriate reference to preceding figures, FIG. 7A shows a flowchart of an exemplary method 700 for using the structure model for determining a table of parameters for a number of structures. Method 700 begins in step 705 when a user defines the structure model, as described above in reference to FIGS. 2-5. In step 710, the structure model 137 is accessed. In step 715 (e.g., typically performed by the modeling software 140), expected metrology data is determined for a number of different defined structures. Such defined structures could have certain incremental changes in T_poly for instance. Step 715 produces a table 720 of structure parameters. For each possible defined structure in step 715, there would be a set of expected metrology data. For instance, one exemplary entry 721 from table 720 is shown in FIG. 7A. Entry 721 has structure parameters 722 and expected metrology data 723. Thus, table 720 stores a number of structure parameters for defined (e.g., discrete) structures.

Turning to FIG. 7B in addition to previous figures, a flowchart is shown of an exemplary method 725 for determining parameters of a structure on a sample using stored parameters for a number of defined structures. Method 725 begins in step 730, when metrology data is determined (see step 625 of FIG. 7). Steps 735, 740, 745, 750, and 755 are typically performed by modeling software 140. In step 735, a defined structure (e.g., defined by structure parameters 722 in table 720) is selected from the table 720. In step 740, the expected metrology data (e.g., expected metrology data 723 retrieved from table 720) and measured metrology data are compared. If the expected metrology data 723 and measured metrology data are within a predetermined tolerance (step 745=YES), then structure parameters 722 are output in step 755. If not (step 745=NO), another structure is selected in step 750 and steps 740 and 745 are performed again.

Thus, in an exemplary embodiment, techniques are provided for description and use of a structure model for scatterometry-based semiconductor manufacturing process metrology. A structure model is accessed, where the structure model defines a cross-sectional profile of a structure on a sample. The cross-sectional profile is defined using one or more blocks. Information from the structure model is evaluated to produce expected metrology data for a scatterometry-based optical metrology. Measured metrology data are determined by examining the structure on the sample using the scatterometry-based optical metrology. A comparison is performed between the expected and measured metrology data in order to determine whether the structure model should be revised. If it determined that the structure model should be revised, a revision to the structure model is performed and the information from the structure model is again evaluated to produce new expected metrology data for the scatterometry-based optical metrology. The process may be repeated until differences between the expected and measured metrology data meet some predetermined error. The predetermined error can be a minimum error determined relative to a number of difference calculations. More than one scatterometry-based metrology may be used, if desired. The structure being analyzed can be a single structure or a structure array.

The foregoing description has provided by way of exemplary and non-limiting examples a full and informative description of the best techniques presently contemplated by the inventors for carrying out embodiments of the invention. However, various modifications and adaptations may become apparent to those skilled in the relevant arts in view of the foregoing description, when read in conjunction with the accompanying drawings and the appended claims. All such and similar modifications of the teachings of this invention will still fall within the scope of this invention.

Furthermore, some of the features of the exemplary embodiments of this invention could be used to advantage without the corresponding use of other features. As such, the foregoing description should be considered as merely illustrative of the principles of embodiments of the present invention, and not in limitation thereof.

What is claimed is:

1. A method comprising:
accessing a structure model defining a cross-sectional profile of a structure on a sample, the cross-sectional profile at least partially defined using a set of blocks, each of the blocks including a plurality of vertices, each vertex expressed using at least one algebraic relationship between a plurality of parameters corresponding to the structure;
evaluating information from the structure model to produce expected metrology data for a scatterometry-based optical metrology;
accessing measured metrology data, the measured metrology data determined by examining the structure on the sample using the scatterometry-based optical metrology; and
comparing the expected metrology data and the measured metrology data in order to determine at least one of the plurality of parameters corresponding to the structure.

2. The method of claim 1, wherein the parameters include at least one of thickness of a polysilicon layer, a critical dimension of a polysilicon layer, a width of a spacer, or a thickness of a nitride layer.

3. The method of claim 1, wherein the parameters define physical elements of the structure.

4. A metrology system comprising:
a processing element configured to access a structure model defining a cross-sectional profile of a structure on a sample, the cross-sectional profile at least partially defined using a set of blocks, each of the blocks including a plurality of vertices, each vertex expressed using at least one algebraic relationship between a plurality of parameters corresponding to the structure, the processing element further configured to evaluate information from the structure model to produce expected metrology data for a scatterometry-based optical metrology, the processing element also configured to access measured metrology data, the measured metrology data determined by examining the structure on the sample using the scatterometry-based optical metrology, and the processing element further configured to compare the expected metrology data and the measured metrology data in order to determine at least one of the plurality of parameters corresponding to the structure.

5. The apparatus of claim 4, further comprising a light source configured to generate a light beam, a first lens configured to direct the light beam onto a surface of the sample, a second lens positioned to direct a version of the light beam that is reflected from the sample onto a detector, and wherein the processing element is configured to access the measured metrology data by accessing information produced by the detector.

6. The apparatus of claim 5, wherein the first lens is configured to focus the light beam onto the surface and therefore to generate a plurality of angles of incidence with respect to the surface.

7. A method comprising:
accessing a structure model defining a cross-sectional profile of a structure on a sample, the cross-sectional profile at least partially defined using a set of blocks, each of the blocks including a plurality of vertices, at least one of the vertices expressed using at least one algebraic relationship between a plurality of parameters corresponding to the structure; and
evaluating information from the structure model to produce expected metrology data for a scatterometry-based optical metrology, the expected metrology data suitable for use for determining at least one of the plurality of parameters corresponding to the structure.

8. The method of claim 7, wherein the parameters include at least one of thickness of a polysilicon layer, a critical dimension of a polysilicon layer, a width of a spacer, or a thickness of a nitride layer.

9. The method of claim 7, wherein the parameters define physical elements of the structure.

10. A metrology system comprising:
a processing element configured to access a structure model defining a cross-sectional profile of a structure on a sample, the cross-sectional profile at least partially defined using a set of blocks, each of the blocks including a plurality of vertices, at least one of the vertices expressed using at least one algebraic relationship between a plurality of parameters corresponding to the structure, wherein the processing element is further configured to evaluate information from the structure model to produce expected metrology data for a scatterometry-based optical metrology, the expected metrology data suitable for use for determining at least one of the plurality of parameters corresponding to the structure.

11. The apparatus of claim 10, wherein the parameters include at least one of thickness of a polysilicon layer, a critical dimension of a polysilicon layer, a width of a spacer, or a thickness of a nitride layer.

12. The apparatus of claim 10, wherein the parameters define physical elements of the structure.
